(19) United States
(12) Patent Application Publication
(10) Pub. No.: US 2006/0010007 A1
(43) Pub. Date: Jan. 12, 2006

(54) Process for using smart card technology in patient prescriptions, medical/dental/DME services processing and healthcare management

(76) Inventors: John F. Denman, Redondo Beach, CA (US); Yair M. Babad, Santa Monica, CA (US)

Correspondence Address: YAIR M. BABAD, 2909 ARIZONA AVENUE, UNIT #13, SANTA MONICA, CA, 90404, US

(21) Appl. No.: 10/819,882

(22) Filed: Jul. 9, 2004

(51) Int. Cl. G06Q 10/00

(52) U.S. Cl. 705/2

(57) ABSTRACT

An integrated process for using smart card technology in patient prescriptions, medical/dental services processing, billing and paying, healthcare management and provision of emergency medical/dental information based on a single, comprehensive, unified system, integrating and interconnecting medical/dental health providers, pharmaceutical providers and manufacturers, insurance companies and other healthcare payers, the Centers for Medicare & Medicaid Services (CMS) and other health-related regulatory authorities, and patients; a Patient's Smart Card (PSC) capable of storing, processing and retrieving medical/dental information, complete medical/dental history, insurance carrier claim record layouts, medical/dental and prescriptions data, eligibility transactions layout, and credit or debit card data; standard-based objects used by CMS and healthcare industry to create, send, receive, update, and process medical/dental history, electronic prescriptions, medical/dental/prescription claims, and medical/dental services; a Individual's Smart Card Interface Device (ISCID), linked to providers systems, to read/write/update PSC data; a Provider's Smart Card Interface Device (PSCID), linked to providers systems, to read/write/update PSC data; a Smart Card Control Kiosk, supporting setting up, reading, writing, and updating of PSC and provider systems, secured backup PSC information, and printing reports; and centralized Smart Card Control System (SCCS) for audit and push-out updating and synchronization of SCCKs and ISCIDs and PSCIDs, maintaining list of recognized healthcare providers, and assure emergency access to PSC data; mapping facilities between various reporting and transmission standards used by the healthcare industry for billing and medical/dental information transfer; and all other software, procedures, interfaces, programs, data and facilities needed to assure the efficient, effective and secure operation of the above.

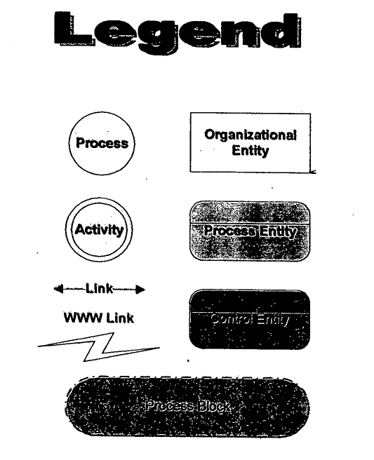

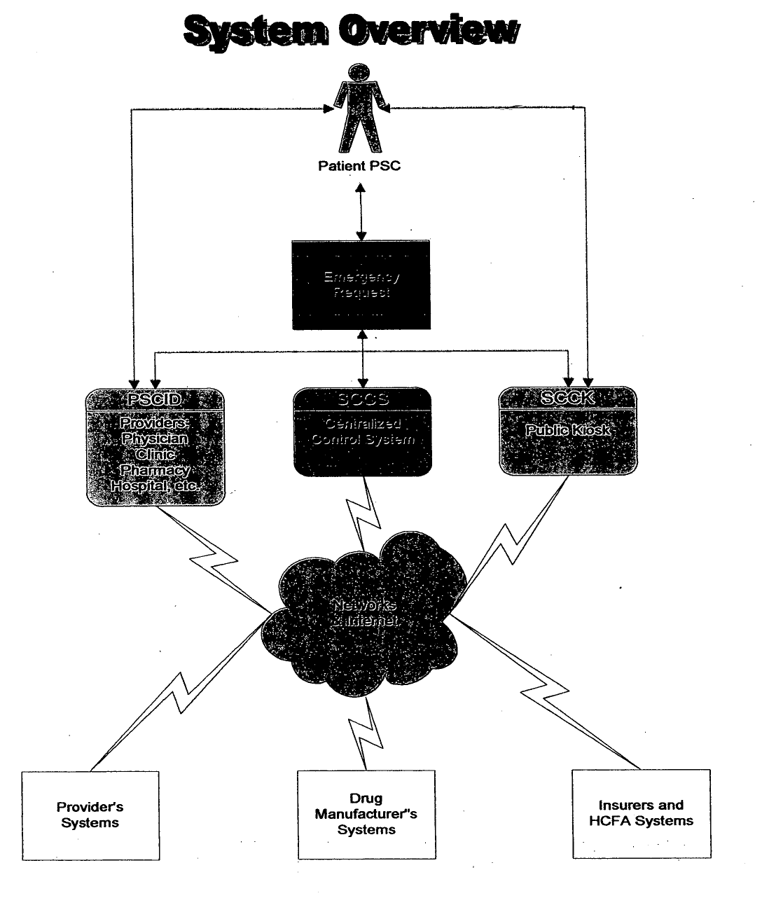

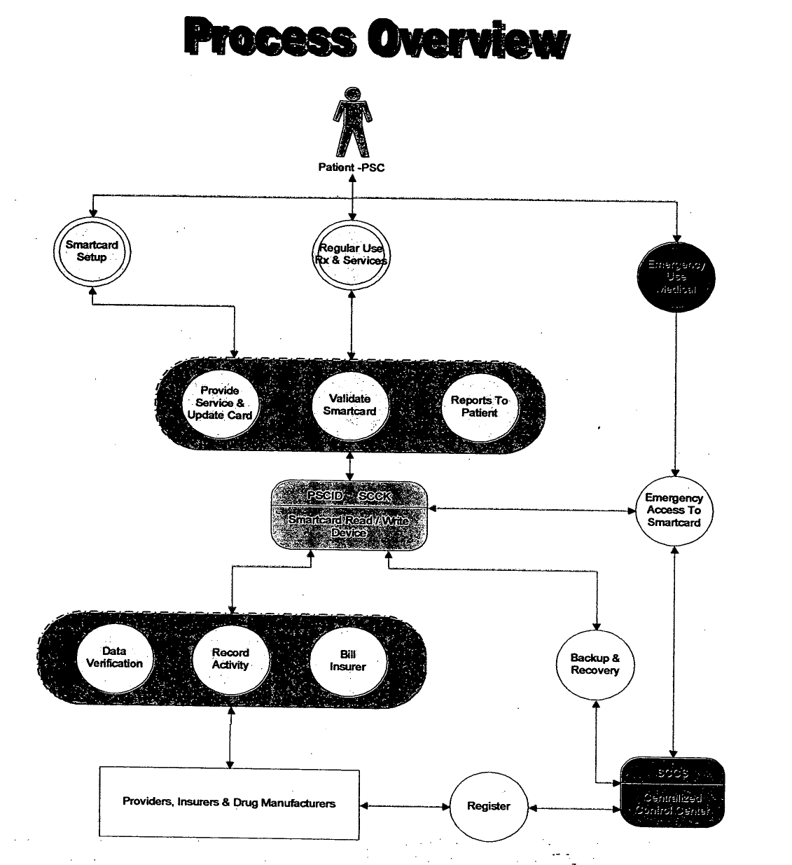

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

Note: Wherever the word “his” or similar reference is used, it means “his/her.”

### BACKGROUND OF THE INVENTION

This invention relates generally to the fields of healthcare, healthcare services, prescription and medical/dental provisions, support of Centers for Medicare & Medicaid Services (CMS) requirements, and more specifically to a process for using smart card technology in patient prescriptions, medical/dental services processing and healthcare management.

### Introduction

Currently there are over 40 million Medicare recipients in the United States, and this number is expected to double by 2030. The cost of the Medicare bill to the federal government is expected to exceed $400 billion over the next 10 years. There are over 1.4 million providers in the U.S. of which about 1 million are hospitals, physicians and medical/dental providers, and of these more than 80% are also in the national Medicare/Medicaid programs and provide medical/dental care for these beneficiaries. Each of these providers sees an average of 26 patients per day, and writes an average of 23 prescriptions per day. With such an ever-increasing volume of activity and the financial pressures faced by these programs, there is an urgent need to expedite the processes associated with tracking patients' medical/dental histories, writing prescriptions, assure that the drugs involved are safe and appropriate for the patients, maintain the privacy of the patients, and secure their information, while minimizing the costs of these activities and the risk of inappropriate prescriptions and improper service.

Well-regarded studies reported in The Register-Guard estimate that mis-prescribed and over-the-counter drugs kill more than 100,000 Americans every year. Another 100,000 die each year in hospitals because of preventable errors. Injuries from medical/dental negligence are estimated at 1 million per year. Thus, there is a substantive need to implement technologies that will significantly lessen such death and injury rates and the costs associated with them. Eliminating needless mistakes would be the easiest and most obvious way to reduce these rates and cut malpractice insurance costs.

The technologies presented in this application and their combined use, are a major step in this desired direction and will go a long way in minimizing such problems. The use of standardized ANSI-based transactions, as mandated by the Centers for Medicare & Medicaid Services (CMS), and the introduction of the Medicare Prescription Improvement and Modernization Act of 2003 (the Act) is another major inducement with considerable economic justification for the implementation of these technologies.

### Approach

The Act provides Medicare recipients, beginning in 2004, the right to purchase a Medicare-endorsed prescription drug discount card, with an anticipated 10-25% discount on drug purchases. We believe that this card should be more than just a plastic or paper identification card. It should be a smart card, capable of storing other medical/dentally related information and transactions data including:
A complete patient medical/dental history.
Insurance carrier electronic claim record-layouts and data for medical/dental and prescription drugs.
Claim, eligibility prescription and other standards-based transaction identification numbers and data by carrier and as mandated by the Centers for Medicare & Medicaid Services (CMS).
A standards-based transaction to transmit new patient prescriptions data to an (international) database, to determine potential and lethal drug combinations based on the patient's current drug usage. Lethal combinations and/or those that may cause allergic reaction would then be immediately returned to the prescribing provider, with recommendations for change.
Medical/dental, drug use and allergies information as needed to support emergency medical/dental treatment.
Credit and/or debit card data.

The use of such a smart card, and the supporting other facilities and entities as described in this innovation, are imperative for efficient and effective filling of all prescriptions and the need for Durable Medical/dental equipment (DME), and the other medical/dental needs of the patients. It will also eliminate many instances of drug and other abuse. Further, an image of the cardholder would be capable of being displayed on a video device, to further preclude fraud.

At the same time, all the data used by the system will be stored in encrypted format, using the best and strongest encryption facilities and software available, to assure privacy and protection of that data. Similarly, and for the same reason, all communications between the innovation's system entities will be encrypted by the best and strongest encryption communication facilities and software.

Given the variability of plan deductibles, co-payments, etc., established by insurance carriers and government sponsored medical/dental plans, there is a need to track such data and keep it current, to be used each time any patient-related medical/dental activity is conducted. Co-payments, deductibles and other accounting data will be stored on the smart card, and will be used for accounting purposes, as well as for determination of eligibility and any changes in payment levels by the cardholder.

We are becoming a global society; with each new advancement in the way people travel. Thus, people require medical/dental attention both at home and away. Should a person become ill while away, the availability, on the smart card, of that person's entire medical/dental and drug use history and allergies may save many lives, and eliminate costly errors associated with a misdiagnosis or lethal drug combinations.

### BRIEF SUMMARY OF THE INVENTION

This application presents a system concept that integrates and interconnects medical/dental health providers, pharmaceutical providers and manufacturers, insurance companies and other healthcare payers, the Centers for Medicare & Medicaid Services (CMS) and other health-related regulatory authorities, and patients, and responds to the aforementioned needs. It is a single comprehensive unified system, using mostly existing technologies, devices and software, all being related and indispensable parts of this system. The innovative element of this application is the overall unified approach to the particular domains of patient prescription processing, medical/dental services processing, and healthcare management, and the sophisticated integration of all the related technologies, devices and software. This is an exploitation of existing technologies to form a unique and unified comprehensive new system to perform all the objectives listed below.

The objectives of the system are to:
1. To provide a fully integrated and interconnected system, to support in real-time, all the objectives listed below.
2. Support prescription writing, medical/dental services, Durable Medical/dental Equipment (DME), prescription needs and provisions, and emergency access to the medical/dental and pharmaceutical information of patients.
3. Support billing, electronic funds transfers and payments to the healthcare and pharmaceutical providers for the aforementioned services by insurance companies and other healthcare payers, and by CMS and other regulatory authorities. To this end, all transaction identifying information will be included on the smart card.
4. Assure that all the related medical/dental profile, history, drug usage, and allergies history of the patient (including drugs that should not be prescribed), and allergies are available at all times as needed, and are considered before drugs and services are provided.
5. Assure that the healthcare providers have all the information needed to assure that the drugs and services provided are safe and appropriate for the patient.
6. Assure universal communications with existing providers, carrier insurance systems and other healthcare payers, pharmacies and pharmaceutical companies, and enable processing, billing, servicing, and data management without need to rewrite or modify their systems.
7. Enhance the mobility of patients, by assuring that all their medical/dental information will be securely “traveling” with them in their Patient Smart Card, thus making it available wherever and whenever the need for it arises.
8. Provide emergency access to the patient's medical/dental, drug use and allergies information by any recognized healthcare provider.
9. Support Standard-based fixed-format objects (such as ANSI/X12N, UNEDIFACT, HL7) and other standard-based medical/dental procedures and drug codes (heretofore “standards”) as currently used and mandated by CMS, other regulatory authorities, and the healthcare industry or as will be used and updated in the future to create, send, receive, update, and process medical/dental history, electronic prescriptions, medical/dental/prescription claims, and other medical/dental services.
10. Support the mappings between the various standards mentioned in objective 9 that may be used by different payers.
11. Maintain the privacy of the patients and secure their information during all the processing noted above.
12. Account for all processed transactions, including deductibles, co-pays and the like.
13. Assure the privacy and security of all the patients' and other data stored and used by the system.
14. Assure fulfillment of all regulatory and standards requirements of CMS and other Federal and State regulatory authorities.
15. Elimination of the Common Working File (CWF) system used by CMS to control deductibles by patients using Part A and B carriers, and in this way increase the efficiency of processing and creates savings.
16. Expedite all the aforementioned processes.
17. Minimize the direct and indirect costs of these aforementioned activities, as well as the time required to their execution.
18. Minimize medical/dental, prescription transmittals, billing and payment errors that may occur during the fulfillment of the aforementioned activities.
19. Minimize medical/dental and prescription fraud, and facilitate the detection of such fraud.

Other objectives and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for using smart card technology in patient prescriptions, medical/dental services processing and healthcare management comprising of:
A single, comprehensive, unified system to support maintenance of medical/dental, prescription and personal records;
A Patient's Smart Card (PSC) capable of storing, processing (in concert with a smart card processing device) and retrieving medical/dentally related information, including a complete patient medical/dental history, insurance carrier electronic standard claim record IDs, data for medical/dental and prescription drugs and Durable Medical/dental Equipment (DME), standard eligibility transactions IDs required by CMS and insurance carriers, and credit/debit card data;
Standard-based fixed-format objects (such as ANSI/X12N, UNEDIFACT, HL7) and other standard-based medical/dental procedures and drug codes as currently used and mandated by CMS, other regulatory authorities, and the healthcare industry or as will be used and updated in the future to create, send, receive, update, and process medical/dental history, electronic prescriptions, medical/dental/prescription claims, and other medical/dental services; and support the mappings between the various standards that may be used by different payers;
A patient Individual's Smart Card Interface Device (ISCID), linked through the personal computer systems of the patient to the centralized Smart Card Control System (SCCS) (below), to read/write/update the patient's data on the PSC;
A Provider's Smart Card Interface Device (PSCID), linked to the computer systems of healthcare providers, to read/write/update the patient's data on the PSC;
A Smart Card Control Kiosk (SCCK), supporting setting up, reading, writing, and updating of the PSC and the related healthcare provided systems, as well as secured backing up the PSC information and printing reports as needed; and
A centralized Smart Card Control System (SCCS) to update and synchronize the SCCKs and PSCIDs through push-out updating, audit their activities, maintain a list of recognized healthcare providers, and assure emergency access to the PSC data. The system will support a network of distributed SCCSs as needed to assure efficient real-time support of all the system elements regardless of geographical distribution of its various uses.

All the data stored and used by the system presented and described by this innovation will be stored in encrypted format, using the best and strongest encryption facilities and software available, to assure privacy and protection of that data. Similarly, and for the same reason, all communications between the system's entities will be encrypted by the best and strongest encryption communication facilities and software.

### BRIEF DESCRIPTION OF THE DRAWINGS

Three drawings, filed separately, constitute a part of this specification and include exemplary embodiments to the invention, which may be in various forms. It is to be understood that in some instances various aspects of the invention may be shown exaggerated or enlarged to facilitate an understanding of the invention. They include a Legend, System Overview and Process. Overview.

The System Overview details the entities involved, the proposed invention's elements, and their interactions. The Process Overview presents the major activities and process used to assure the fulfillment of the invention's objectives, and their relation to the invention's elements.

Systems Overview (See Drawing Filed Separately.).

The participating entities include the patient seeking prescriptions, Durable Medical/dental Equipment (DME) and medical/dental services, and the healthcare and pharmaceutical providers that fulfill the patient's needs. These include, for example, pharmacies, clinics, hospitals, physicians, and laboratories, as well drug manufacturers (which are an essential part of the prescription fulfillment supply chain and are also directly involvement with patients through drug testing), healthcare insurers and other healthcare payers, the CMS Medicare and Medicaid programs, and other health-related regulatory authorities.

The patient carries with him his PSC smartcard, capable of storing, processing and retrieving medical/dentally related information, including a complete patient medical/dental history, insurance carrier electronic claim record layouts, data for medical/dental needs, DMEs and prescription drugs, eligibility transactions layout required by CMS and insurance carriers, and credit data. Normally he will either use his personal ISCID smartcard device, or go to get service from a healthcare provider where his card will be read by the PSCID smartcard device, or he will approach a public SCCK kiosk for services such as prescription reordering, queries, information printing, and information updating. Alternatively, he may need emergency medical/dental services, either at home or while traveling. If he is conscious he may give access to his smartcard PSC to the medical/dental service provider; but if he is unconscious, or unable to communicate, the medical/dental service provider will have to request the system's centralized control system SCCS to provide him with access to the patient's smartcard PSC. Once such access is provided, the medical/dental service provider will access the information on the PSC through the smartcard ISCID or PSCID devices.

Both the ISCID and PSCID smartcard devices and the public kiosk SCCK facility will read the card, identify the patient, and access his medical/dental and prescription history. Depending on the patient's needs and requests, the ISCID, PSCID and SCCK will access the systems of the entities that will provide and fulfill the request, and get involved in all the data processing needs related to this request. During the fulfillment of the request the ISCID, PSCID and SCCK will update the information stored on the PSC smartcard of the patient, while the provider's system will be updated based on the information provided them by the ISCID, PSCID and SCCK. All communications between the SCCS, ISCID, PSCID, SCCK, and the providers' systems will be done through the Internet and other networks.

To assure privacy and protection of that data, all communications between the system's entities will be encrypted by the best and strongest encryption communication facilities and software.

Process Overview (See Drawing Filed Separately.)

The key processes associated with the patient all relate to the setup and use of the patient's PSC smartcard, and are performed in a cooperative way by the patient's PSC smartcard and the smartcard ISCID, PSCID and SCCK devices. The ISCID, PSCID and SCCK devices are also involved with communications and processing related to the healthcare provided systems, done for fulfillment of the patient's requests and updating of his PSC smartcard. Finally, the smartcard readers communicate with the centralized control center SCCS; this is done for two purposes: in the “normal” activity, the SCCS is used as a backup facility for the innovation's related information that is stored on the ISCID, PSCID and SCCK smartcard devices. In emergency situations, when a non-communicating patient's needs medical/dental attention, the ISCID, PSCID and SCCK smartcard devices communicate with the centralized control center SCCS for access information to the patient's smartcard. Once such information is provided, the readers can read the patient's PSC card and use the information stored on the smartcard. Finally, each provider must register with the centralized control center SCCS, so that his registration information will be available for use by the patients who request his services.

All the data stored in the system's elements (the PSC, ISCID, PSCID, SCCK, and SCCS), all the processing done by the system's elements, and the data transferred and communicated between the system's elements, will use standards-based objects (e.g., following the ANSI/X12N-UNEDIFACT standards and other standards currently used by Health Care Financial Administration (CMS), other regulatory authorities, and these providers and insurers) to create, send, receive, update, and process medical/dental history, electronic prescriptions, and medical/dental/prescription claims to drug and medical/dental services providers (such as drug stores, pharmaceutical firms, laboratories, etc.). All the data will be stored in encrypted format, using the best and strongest encryption facilities and software available, to assure privacy and protection of that data. Similarly, and for the same reason, all communications between the system's entities will be encrypted by the best and strongest encryption communication facilities and software.

The key players of this system's design are health care beneficiaries (patients) who carry any form of health insurance either provisioned by insurance companies (insurers/carriers), the Centers for Medicare & Medicaid Services (CMS) or state sponsored plans like Medicaid. Regardless of their economic status, all are subject to misdiagnosis by providers (doctors, dentists, hospitals, pharmacies and other drug providers/manufacturers, clinics, and the like) when those providers lack sufficient data about the patient's medical/dental history, drug usage, and the like. Moreover the ability to effectively communicate such information among these players is extremely poor, if non-existent. We believe that effective change does not occur in the absence of knowledge. Therefore, the design of this system is intended to take a quantum leap forward in improving the knowledge of the players by overcoming this communications problem and reducing the number of misdiagnoses medical/dentally and the number of prescriptions for drugs that harm or kill patients when used in combination with other drugs, when the provider is unaware of the use of other drugs being used by the patient or the potential and lethal affect of such combinations.

In addition, it is also designed to enhance the overall administrative processes of medical/dental care and funding by using standards based transaction sets to write prescriptions, claims, eligibility requests and the like that must move rapidly, correctly and securely among all of the players.

What follows is a sample of some of the step-by-step series of processes that describe the overall view of the system's components and activities:

| Step | Who | Description |
|---|---|---|
| 1. | Health & Drug Providers, | Transmit pertinent smart-card |
| | Insurers, CMS, and | data on patients to the Central- |
| | Medicaid Systems | ized Control System (SCCS) via |
| | | the network. |
| 2. | Centralized Control | Edit, merge and create the |
| | System | Patient Smart Cards (PCS) for |
| | | manufacture. Create and distrib- |
| | | ute the PCS cards and a report |
| | | on content to Patients. |
| 3. | Patient (or Guardian) | Review card content report and |
| | | request corrections at an SCCK |
| | | public kiosk (for contact, |
| | | identification, address, credit |
| | | card, or debit card data only) |
| | | or through the applicable |
| | | health/drug providers, insurers, |
| | | CMS or Medicaid, or through the |
| | | ISCID or PSCID. |
| 4. | Centralized Control | Review and make corrections. |
| | System | Update the PSC over the |
| | | network as required. |
| 5. | Patient | Use the PSC when visiting any |
| | | provider to identify yourself |
| | | and for related services and |
| | | updates in medical/dental data, |
| | | prescriptions data, tracking |
| | | and administration. |
| 6. | Providers | Transmit prescriptions to the |
| | | appropriate provider, and/or |
| | | process ANSI/UNEDIFACT transac- |
| | | tions as formatted on the PSC, |
| | | including claims, eligibility, |
| | | medical/dental updates, etc. |
| 7. | Emergency Service | Use the PSC to review the |
| | Providers | patient's medical/dental |
| | | history, prescribe drugs, and |
| | | updates if available. |
| | | Otherwise, access the SCCS |
| | | Centralized Control System for |
| | | that data and updates. |
| 8. | Centralized Control | Update the PSC with emergency |
| | System | services data whenever the card |
| | | is inserted in a valid read/ |
| | | write device. |
| 9. | Drug Providers | Receive and fill electronic |
| | | prescriptions. Notify medical/ |
| | | dental providers of negative |
| | | drug interactions if needed and |
| | | update the PSC as needed with |
| | | new drug data. |
| 10. | Network/Internet | Secure and deliver all |
| | Services | transactions data as required. |

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The system integrates and interconnects medical/dental health providers, pharmaceutical providers and manufacturers, insurance companies and other healthcare payers, the Centers for Medicare & Medicaid Services (CMS) and other health-related regulatory authorities, and patients. The system supports prescription writing, medical/dental services, Durable Medical/dental Equipment (DME) needs and provisions, and emergency access to medical/dental and pharmaceutical information of patients. The system also supports billing, electronic fund transfers and payments to the healthcare and pharmaceutical providers for the aforementioned services by insurance companies and other healthcare payers, and by CMS and other regulatory authorities. Last, but not least, the system supports emergency access to medical/dental and pharmaceutical information of patients. While the system includes several sub-systems, it is a single integrated and interconnected system; all of these are indispensable elements of the overall system, and all required for its successful operation. The system will use the latest communications wireless and identification technology, such as Wi-Fi and RFID, to simplify and expedite communications between its elements, in addition to the use of the World-Wide Web and the Internet. Specifically, the system will include the following:
A. The “heart” of the system is a Patient's Smart Card (PSC) that securely stores and processes, among other information, the patient's:
   a. Identification information, including—but not restricted to—personal details such as personal identification id, addresses, phone numbers; visual image such as photographs; and other identifying information as appropriate such as fingerprint.
   b. Family information for use in case of emergency, such as names of relatives and how to access them.
   c. Medical/dental profile.
   d. Medical/dental history.
   e. List of allergies as developed from time to time.
   f. Drug utilization data.
   g. List of drugs to avoid.
   h. List of authorized family and related persons covered by the coverage of the cardholder;
   i. List of people authorized to make changes to the information on the card and/or in the system, with specific details on the authorizations granted to each.
   j. List of approved providers who may securely access the patient's data, and their access privileges.
   k. Insurance coverage data.
   l. Financial and credit data to pay for deductibles, co-pays, drugs and other medical/dental services electronically.
   m. Accounting data for tracking co-payments and deductibles.
B. To assure universality of access to and communication with the providers and insurers in the U.S., standards-based objects (e.g., following the ANSI/X12N-UNEDIFACT standards and other standard-based medical/dental procedures and drug codes (heretofore “standards”) as currently used and mandated by CMS, other regulatory authorities, and the healthcare industry or as will be used and updated in the future) will be used throughout the system to create, send, receive, update, and process medical/dental history, electronic prescriptions, and medical/dental/prescription claims to drug and medical/dental services providers (such as drug stores, pharmaceutical firms, laboratories, etc.). In particular, all the processes on the Patient's Smart Card will use these objects, including but not limited to:
X12N 837—Health Care Claim, Dental—Beneficiary's Carrier Release.
X12N 837—Health Care Claim, Professional—Beneficiary's Carrier Release.
X12N 837—Health Care Claim, Institutional—Beneficiary's Carrier Release.
X12N 834—Benefit Enrollment and Maintenance—Beneficiary's Carrier Release.
X12N 820—Payroll Deducted and Other Group Premium Payment for Insurance Products.
X12N 278—Health Care Services Request for Review and Response—Beneficiary's Carrier Release.
X12N 276—Health Care Claim Status Request.
X12N 277—Health Care Claim Status Response.
X12N 270—Health Care Claim Eligibility Inquiry—Beneficiary's Carrier Release.
X12N 271—Health Care Claim Eligibility Response—Beneficiary's Carrier Release.
X12N 148—Report of Injury or Illness.
X12N 186—Life and Annuity Lab Report.
X12N 275—Patient Information (which will be kept in full, to assure all time access to this information when needed, regardless of the other elements of the system).
   a. An electronic Rx will be added with ANSI-UNEDIFACT approval.
   b. A mapping between the different standards and/or different versions of the standards as used by different payers, to assure communications and information transfer between all the healthcare providers and healthcare payers that are linked to the system.
   c. The elimination of the current Common Working File (CWF) system that is employed for CMS's transaction processing employed for CMS's transaction processing to determine patient's Part A and Part B deductibles, using an simple interface to a Federal System that would update these values for Medicare cardholders, is also part of this invention.
C. A patient Individual's Smart Card Interface Device (ISCID), linked through the personal computer systems of the patient to the SCCS (below), will securely enable the following activities, among others:
   a. Reorder of drugs and services that have renewable prescriptions.
   b. Enable remote updating of PSC stored information, such as renewal of prescriptions, adding lab results to the medical/dental history stored on the PSC, etc.
   c. Enable remote updating of approved providers' databases, by sending them data from the PSC. This, for example can be used to remotely update the data of the primary physician, even while the patient is traveling.
   d. Update the list and privileges of the approved providers for the patient.
   e. Update the insurance coverage data of the patient.
   f. Update the security aspects of the system, such as the patient PIN and the encryption key used for backup.
   g. Secured backup of the encrypted PSC data; the encryption assures that while the data is backed up, it is still secured and inaccessible to others.
   h. Provide services such as printing and reporting to the patient of the PSC data.
   i. Update of the standards-based objects and the PSC software, on the basis of push-out updating (i.e., when the PSC is entered into the ISCID, it is automatically updated if an update is pending).
   j. The output of the providers' activities, such as prescriptions, lab and test results, physicians' diagnoses, etc., will be written by the ISCID unto the PSC, thus updating the PSC's database.
   k. The ISCID will use the standards-based objects for communication and processing, thus assuring its adaptability for use with existing providers and insurers systems, without making any modification to these systems.
D. A Provider's Smart Card Interface Device (PSCID), linked to the computer systems of the provider, to read/write/update the patient's data as needed; such access will only be enabled to approved providers as stored on the PSC. Among other activities, the PSCID (and similarly the ISCID) will provide for:
   a. The output of the providers' activities, such as prescriptions, lab and test results, physicians' diagnoses, etc., will be written by the PSCID (and similarly by the ISCID) unto the PSC, thus updating the PSC's database.
   b. The integrated operation of the PSC and the PSCID (and similarly by the ISCID) is the key to achieving the goals of the system. The PSCID (and similarly by the ISCID) will use the standards-based objects for communication and processing, thus assuring its adaptability for use with existing providers and insurers systems, without making any modifications to these systems, or with minimal modifications as required for the efficient and effective operation of the system.
   c. When an emergency patient has to receive medical/dental services, the PSCID (and similarly by the ISCID) will access the centralized Smart Card Control System (below) to receive one time access to the medical/dental information stored on the PSC.
E. A Smart Card Control Kiosk (SCCK), usually available in certain public locations and large providers facilities, including the CMS offices, will securely enable the following activities, among others:
   a. Reorder of drugs and services that have renewable prescriptions.
   b. Enable remote updating of PSC stored information, such as renewal of prescriptions, adding lab results to the medical/dental history stored on the PSC, etc.
   c. Enable remote updating of approved providers' databases, by sending them data from the PSC. This, for example, can be used to remotely update the data of the primary physician, even while the patient is traveling.
   d. Update the list and privileges of the approved providers.
   e. Update the insurance coverage data.
   f. Update the security aspects of the system, such as the patient PIN and the encryption key used for backup.
   g. Secured local (i.e., SCCK) backup of the encrypted PSC data; the encryption assures that while the data is backed up, it is still secured and inaccessible to others.
   h. Provide services such as printing and reporting to the patient of the PSC data.
   i. Initial setup of the PSC and the appropriate data for a patient.
   j. Update of the standards-based objects and the PSC software, on the basis of push-out updating (i.e., when the PSC is entered into the SCCK, it is automatically updated if an update is pending).
F. A centralized Smart Card Control System (SCCS), which will be used, among others:
   a. To update all the SCCKs and ISCIDs and PSCIDs through push-out updating synchronized with all the elements of the system (such as the standards-based objects and the software), through a high-speed public domain highly secured Internet connection.
   b. Monitor and audit the activities of the SCCKs, national backup of the various SCCKs, etc.
   c. Maintain a list of recognized providers, to be used in case of emergencies.
   d. When an emergency patient has to receive medical/dental services by a non-approved (to the patient, as reflected in his or her PSC) but recognized and listed (on the SCCS) medical/dental provider, and upon the request of this provider, provide a one-time access to the patient's PSC by the individual's ISCID or the provider's PSCID to enable access the medical/dental information stored on the PSC and the provision of medical/dental treatment.
   e. The system will support a network of distributed SCCSs as needed to assure efficient real-time support of all the system elements regardless of geographical distribution of its various uses.

The card will also be used, within the limitations of HIPAA and other privacy regulations, for fraud prevention. To this end, the system will provide, among other security measures, for display of an image of the cardholder on a video device.

All the data used by the invention's system will be stored in encrypted format, using the best and strongest encryption facilities and software available, to assure privacy and protection of that data. Similarly, and for the same reason, all communications between the system's entities will be encrypted by the best and strongest encryption communication facilities and software.

It is re-emphasized that while the underlying technologies already exist, the unique overall system presented herein that exploits them, does not exist. This application describes that system in detail for the purpose of establishing a patent and related copyrights of its approach, design, utility, and unique processes.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is, regardless of the order in which claims are presented below: A design process and system for using smart card technology in patient prescriptions, medical/dental services processing, emergency medical/dental services, and healthcare management comprising—among other elements but not limited to—of:

1. A single, comprehensive, unified system (heretofore the “system”) to support maintenance of medical/dental, prescription and personal and history records, integrating and interconnecting medical/dental health providers, pharmaceutical providers and manufacturers, insurance companies and other healthcare payers, the Centers for Medicare & Medicaid Services (CMS) and other health-related regulatory authorities, and patients;

2. The system supports prescription writing, medical/dental services, Durable Medical/dental Equipment (DME) needs and provisions, and emergency access to medical/dental and pharmaceutical information of patients;

3. The system also supports billing, electronic fund transfers and payments to the healthcare and pharmaceutical providers for the aforementioned services by insurance companies and other healthcare payers, and by CMS and other regulatory authorities;

4. The system supports emergency access to medical/dental and pharmaceutical information of patients;

5. The system provides interactive access to the stored information by to the medical/dental health providers, pharmaceutical providers and manufacturers, insurance companies and other healthcare payers, the Centers for Medicare & Medicaid Services (CMS) and other health-related regulatory authorities, and the patients;

6. A Patient's Smart Card (PSC) capable of storing, processing and retrieving medical/dentally related information, including a complete patient medical/dental history, insurance carrier electronic claim record and standard transaction identification and procedure/prescription codes layouts, data for medical/dental and prescription drugs, eligibility transactions layout required by CMS and insurance carriers, and credit data;

7. Standard-based objects (such as ANSI/X12N, UNEDIFACT, HL7) and other standard-based medical/dental procedures and drug codes (heretofore “standards”) as currently used and mandated by CMS, other regulatory authorities, and the healthcare industry or as will be used, developed, enhanced and updated in the future to create, send, receive, update, and process medical/dental history, electronic prescriptions, medical/dental/prescription claims, and other medical/dental services;

8. A mapping between the different standards and/or different versions of the standards as used by different payers, to assure communications and information transfer between all the healthcare providers and healthcare payers that are linked to the system.

9. The elimination of the current Common Working File (CWF) system that is employed for CMS's transaction processing to determine patient's Part A and Part B deductibles, using a simple interface to a Federal System that would update these values for Medicare cardholders, is also part of this invention.

10. A patient Individual's Smart Card Interface Device (ISCID), linked through the personal computer systems of the patient to the centralized Smart Card Control System (SCCS) (below), to read/write/update the patient's data on the PSC;

11. A Provider's Smart Card Interface Device (PSCID), linked to the computer systems of healthcare providers, to read/write/update the patient's data on the PSC;

12. A Smart Card Control Kiosk (SCCK), supporting setting up, reading, writing, and updating of the PSC and the related healthcare provided systems, as well as secured backing up the PSC information and printing reports as needed;

13. A centralized Smart Card Control System (SCCS) to update and synchronize the SCCKs and ISCIDs and PSCIDs through push-out updating, audit their activities, maintain a list of recognized healthcare providers, and assure emergency access to the PSC data.

14. Programs and facilities to support and enable proper operation and execution of the activities noted in all of these claims;

15. Programs and facilities to determine the identity of a patient presenting the Smart PSC card to the ISCID, PSCID and/or SCCK;

16. Programs and facilities to add patients to the system;

17. Programs and facilities to distribute the Smart Card to verified patients, and to replace such cards when necessary;

18. Programs and procedures to prevent unauthorized changes to the medical/dental/prescription history maintained on the PSC and/or in any other element of the system;

19. Programs and procedures to update in real-time the procedure and prescription codes used by healthcare providers on the PSC;

20. Programs and procedures to update in real-time the patient's profile as maintained by healthcare providers and payers, once such changes have been made by the cardholder and/or authorized person;

21. Programs and facilities to update the lists of approved healthcare and pharmaceutical providers recognized by the system;

22. Programs and facilities to update the lists of insurance companies and other healthcare payers;

23. Programs and facilities to update in real-time the medical/dental procedures and prescriptions codes on the PSC, so that they will match the codes used by the healthcare providers and payers at all times and for all the medical/dental history of the patient;

24. Programs and facilities to back up the system's information on the SCCS, and if needed to restore it to the SCCKs and ISCIDs and PSCIDs;

25. Programs and facilities to verify, in real-time, the operational and proper operations of the various system elements by the SCCS;

26. Programs and facilities to report to insurance companies, healthcare payers, CMS, and other regulatory authorities suspected fraud, improper use of the Smart Card, and/or improper billing or payment;

27. Programs and facilities to prevent the use of a particular PSC, or the inclusion of a healthcare or pharmaceutical provider in the list of authorized providers, when such a need arise;

28. Programs and procedures to update in real-time, and distribute to all the system's elements on a pushdown and/or as needed, all the mappings between the different standards and different versions of these standards as used or will be used by the healthcare providers and payers linked to the system;

29. Programs and procedures to update in real-time, and distribute the result in a pushdown and/or as needed basis, all activities needed for the elimination of the aforementioned current Common Working File (CWF) system:

30. Facilities and software to connect all the multiplicity elements of the system in various locations as described above, whether with the patient (such as the PSC and ISCID), with healthcare and prescription providers or other entities (such as the PSCID), in public locations (such as the SCCK), or the central control facility SCCS, through the World-Wide Web and the Internet;

31. Encryption facilities and software to assure that all the data used by the system or communicated by its entities will be stored and in encrypted format, using the best and strongest encryption, thus providing privacy and protection of that data;

32. Facilities and programs to support and maintain in real-time a network of distributed SCCSs as needed, to assure efficient real-time support of all the system elements regardless of geographical distribution of its various uses, and to assure their consistency at all times;

33. Facilities and programs to support and maintain in real-time a network of distributed SCCSs as needed, to assure efficient real-time support of backup activities between the various SCCSs; and

34. All the related software, programs, interfaces, input screens and facilities, reports and displays, databases, communications protocols and software, programs and software and facilities and interfaces to enable access and use of the Internet, and other information systems facilities needed in the system and/or in each of the system's elements described above to accomplish the activities specified in claims all the claims above, and in the system and process views above, using the system elements and entities mentioned herein.
